(19) United States
(12) Patent Application Publication
(10) Pub. No.: US 2011/0308857 A1
(43) Pub. Date: Dec. 22, 2011

(54) INSULATED MULTI-WIRE ELECTRICAL CONNECTOR

(76) Inventor: Edwin Zapata, Brooklyn, NY (US)

(21) Appl. No.: 12/821,126

(22) Filed: Jun. 22, 2010

(51) Int. Cl. H01R 4/18

(52) U.S. Cl. 174/88 R

(57) ABSTRACT

A multi-wire connector crimps a number of distributor wires to connect with a power wire to serve multiple electrical uses. Interior malleable electrically conductive material may comprise a conductive metal including copper, nickel plated metal, aluminum or other conductive metal which crimps easily over existing wire ends inserted in the multi-wire connector. An outer insulation material, such as an electrically insulating waterproof synthetic material, overlaps the insulation on the wires for a permanent instant multiple wire connector having its own insulation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to electrical terminal connectors and particularly to an insulated multi-wire electrical connector comprising a deformable conductive metal interior body and a non-conductive, form fitting, hard plastic external covering; the metal interior body comprises a series of openings for receiving the end of a wire and may be Y-shaped, T-shaped, L-shaped, H-shaped, X-shaped, star-shaped, forked, branched, angled, an elongated tube or alternately in a split connection non-conductive arrangement in a side by side configuration or a X-shaped configuration.

2. Description of Related Art Including Information Disclosed Under 37 CFR 1.97 and 1.98

Insulated electrical connectors in the form of two wire terminals, connectors or splices are well known in the art and are commonly constructed of a metal ferrule inside of a plastic non-conductive sleeve. When a wire end is placed inside an opening on an end of the terminal, a user crimps the terminal with a crimping tool to secure the wire in place. The procedure is repeated with a second wire end which is placed inside the opposite end of the terminal.

None of the prior patents provide a multi-wire connector which crimps a number of branch wires to connect with a power wire to serve multiple electrical appliances in a connector which crimps each wire in place and has its own outer insulation which overlaps the insulation on the wires for a permanent instant multiple wire connector having its own insulation.

U.S. Pat. No. 4,615,114, issued Oct. 7, 1986 to Jones et al, is for a molded buswork and method of manufacturing the buswork, including a conductive T-shaped member having openings at the ends, insulated cables having the insulation at the ends of the cables stripped away to expose the ends of the conductors, an individual exposed conductor being crimped in each open end of the conductive member, the conductive member being supported in a cavity mold by the cables, the cavity mold being filled with a thermal-setting silicone rubber, the silicone rubber curing in the mold to encapsulate and bond to the conductive member, the exposed ends of the conductors, and the insulation on each cable.

U.S. Pat. No. 3,496,284, issued Feb. 17, 1970 to Astrove, provides an electric cable connector with bulging contour for taping. The connector comprises openings for receiving the stripped ends of three or more electrical conductors. Once the an end is put in an opening the connector is crimped to hold the conductor end in place. The connector may be T-shaped, H-shaped, or branched.

U.S. Pat. No. 3,517,112, issued Jun. 23, 1970 to Wahl, shows in FIGS. 3 and 18 a T-shaped electrical terminal connector for sodium cable in which the cable ends are held in place inside the connector's openings using spring force. There is provided an alternate embodiment which has a plastic non-conductive sleeve structure and in which the wire end is held in place by crimping the inner conductive sleeve structure.

U.S. Pat. No. 3,513,249, issued May 19, 1970 to James, claims an X-shaped explosion connector for joining the ends of wires or cables. The device comprises a substantially non-deformable outer shell, at least one deformable inner shell, explosion means located between the outer jacket and the inner shell to cause the shell to deform into crimping contact with the wire ends, and insulating means to prevent shock.

U.S. Pat. No. 3,185,762, issued May 25, 1965 to Shaw, describes a right-angle cable connector which is crimped over portions of a cable with no built-in insulation provided.

U.S. Pat. No. 3,015,685, issued Jan. 2, 1962 to Gerlach et al, discloses a split connector for holding two electrical cables in a non-conductive side by side arrangement. The body of the device has two parallel openings which are designed to hold two cables side by side. The body is deformed by crimping to hold the cables in place. No insulation is provided.

U.S. Pat. No. 2,779,842, issued Jan. 29, 1957 to Walker, indicates a two-part snap together device to establish and electrical connection with pointed barbs inserted into the wires and no insulation provided. A T-shaped embodiment is shown in FIGS. 6 and 7.

U.S. Pat. No. 3,001,000, issued Sep. 19, 1961 to Wantz, Jr., puts forth electrical compression connectors for tapping a line. FIG. 7 shows a right angle or L-connector with a deformable body that is crimped to the conductor with no insulation provided.

U.S. Patent Application #20050178577, published Aug. 18, 2005 by Duesterhoeft et al, illustrates a contact which includes a T-shaped body having a longitudinal dimension and a transverse dimension defining a first channel being configured to receive a conductor extending along the longitudinal direction, and a second channel configured to receive a conductor extending along the transverse dimension. At least one of a lance and a tooth extend from each of the first and second channels to secure the respective conductors thereto.

What is needed is an insulated electrical connector which can connect a multiplicity of wires in one unit with a simple crimping action for each wire.

### BRIEF SUMMARY OF THE INVENTION

An object of the present invention is to provide a multi-wire connector which crimps a number of branch wires to connect with a power wire to serve multiple electrical appliances in a connector which crimps each wire in place and has its own outer insulation which overlaps the insulation on the wires for a permanent instant multiple wire connector having its own insulation.

In brief, a multi-wire connector crimps a number of branch wires to connect with a power wire to serve multiple electrical appliances. Interior malleable electrically conductive material may comprise a conductive metal including copper, nickel plated metal, aluminum or other conductive metal which crimps easily over existing wire ends inserted in the multi-wire connector. An outer insulation material, such as an electrically insulating waterproof synthetic material, overlaps the insulation on the wires for a permanent instant multiple wire connector having its own insulation.

Each multi-wire connector is sized to connect wires of specific gauges for a tight fit therein with an electrically insulated weather tight fit. The outer surface may be heat shrink material to form a permanent waterproof and electrically insulated coating over the entire connection.

A wide variety of shapes and sizes of multi-wire connectors may be fabricated for different uses and with different numbers of connector arms depending upon how many wires need to be interconnected. Color coding may indicate the intended application of each multi-wire connector.

The multi-wire connectors are fabricated in a wide variety of shapes for different applications including but not limited to multi-wire connectors having a “Y” shape, “T” shape, “H” shape, star shape, multi-fingered shape, “L” shape, double “L” interconnected shape, cross shape, bisected angle shape, tuning fork shape, parallel line shape, “H” shape with extending horizontal element, or other desired shape.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a cross-sectional view taken through a vertical centerline of a Y-shaped insulated electrical connector of the present invention with two wires connecting to the bottom live wire through the internal electrical conductor;

FIG. 2 is a cross-sectional view taken through the vertical centerline of the Y-shaped insulated electrical connector of FIG. 1 showing each of the wires crimped to secure the wires together through the internal electrical conductor;

FIG. 3 is an elevational view of the Y-shaped insulated electrical connector of the present invention showing the electrical conductor in dashed lines within the outer electrical insulation;

FIG. 4 is an elevational view of a three-armed insulated electrical connector of the present invention showing the electrical conductor in dashed lines within the outer electrical insulation to connect between the bottom live wire arm and the three upper distributor wire arms;

FIG. 5 is an elevational view of a four-armed insulated electrical connector of the present invention showing the electrical conductor in dashed lines within the outer electrical insulation to connect between the bottom live wire arm and the four upper distributor wire arms;

FIG. 6 is an elevational view of an elbow or L-shaped insulated electrical connector of the present invention showing the electrical conductor in dashed lines within the outer electrical insulation to connect between the top live wire arm and the bottom orthogonal wire arm;

FIG. 7 is an elevational view of a double L-shaped insulated electrical connector of the present invention showing two separate L-shaped electrical conductors in dashed lines within the outer electrical insulation to connect between the left live wire arm and the upper orthogonal distributor wire arm and between the lower live wire arm and the right distributor wire arm;

FIG. 8 is an elevational view of an arrowhead-shaped insulated electrical connector of the present invention showing the electrical conductor in dashed lines within the outer electrical insulation to connect between the left vertical live wire arm and the acute angled distributor wire arm and the orthogonal distributor wire arm;

FIG. 9 is an elevational view of an X-shaped (or cross-shaped) insulated electrical connector of the present invention showing the electrical conductor in dashed lines within the outer electrical insulation to connect between the bottom left live wire arm and the three distributor wire arms;

FIG. 10 is an elevational view of a five-fingered insulated electrical connector of the present invention showing the electrical conductor in dashed lines within the outer electrical insulation to connect between the two bottom live wire arms and the five upper distributor wire arms;

FIG. 11 is an elevational view of an eight pointed star or pinwheel shaped insulated electrical connector of the present invention showing the electrical conductor in dashed lines within the outer electrical insulation to connect between the bottom live wire arm and the seven distributor wire arms;

FIG. 12 is an elevational view of an inverted T-shaped insulated electrical connector of the present invention showing the electrical conductor in dashed lines within the outer electrical insulation to connect between the top live wire arm and the two lower orthogonal distributor wire arms;

FIG. 13 is an elevational view of an H-shaped insulated electrical connector of the present invention showing the electrical conductor in dashed lines within the outer electrical insulation to connect between the top left live wire arm and the three distributor wire arms;

FIG. 14 is an elevational view of an H-shaped insulated electrical connector of the present invention showing the two non-connected vertical electrical conductors in dashed lines within the outer electrical insulation to connect between the two upper live wire arms and the two lower distributor wire arms separately;

FIG. 15 is an elevational view of an H-shaped insulated electrical connector of the present invention having an extension of the center cross bar beyond the two verticals on both sides, and showing the electrical conductor in dashed lines within the outer electrical insulation to connect between the left live wire arm and the five distributor wire arms;

FIGS. 16A-16D are each an elevational view in a different length of an elongated straight insulated electrical connector of the present invention showing the electrical conductor in dashed lines within the outer electrical insulation to connect between the top live wire arm and the bottom distribution wire arm;

FIG. 17 is an elevational view of a rectangular insulated electrical connector of the present invention showing two non-connected vertical electrical conductors in dashed lines within the outer electrical insulation to connect between the two upper live wire arms and the two lower distributor wire arms separately;

FIG. 18 is an elevational view of a tuning fork shaped insulated electrical connector of the present invention showing the electrical conductor in dashed lines within the outer electrical insulation and a left live wire arm connecting with two right distributor wire arms.

### DETAILED DESCRIPTION OF THE INVENTION

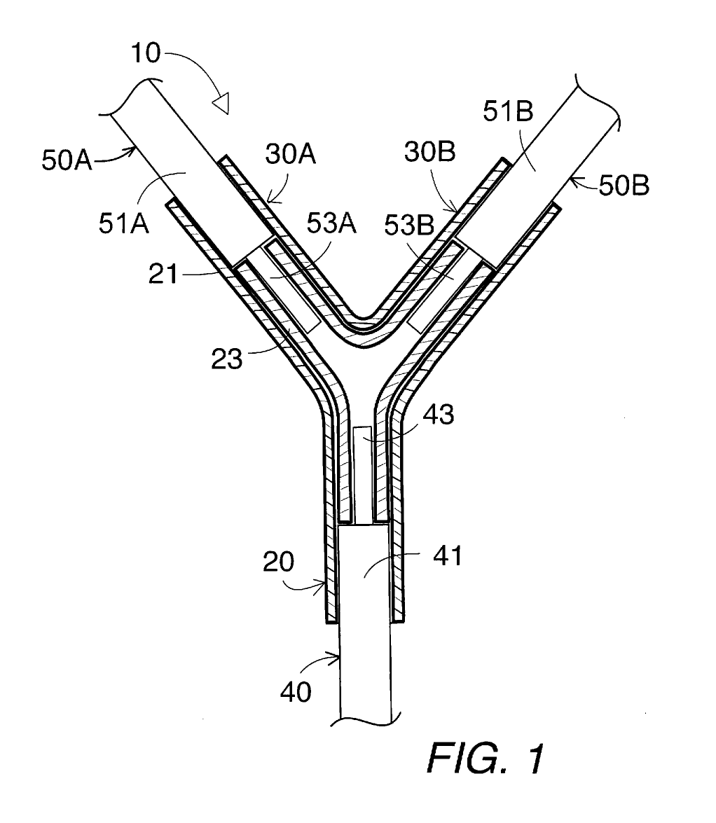

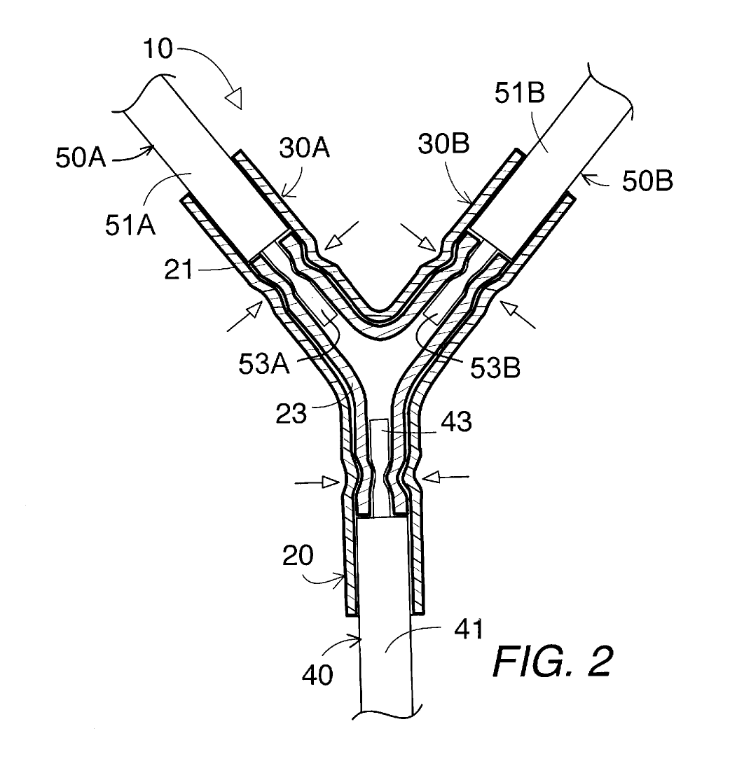

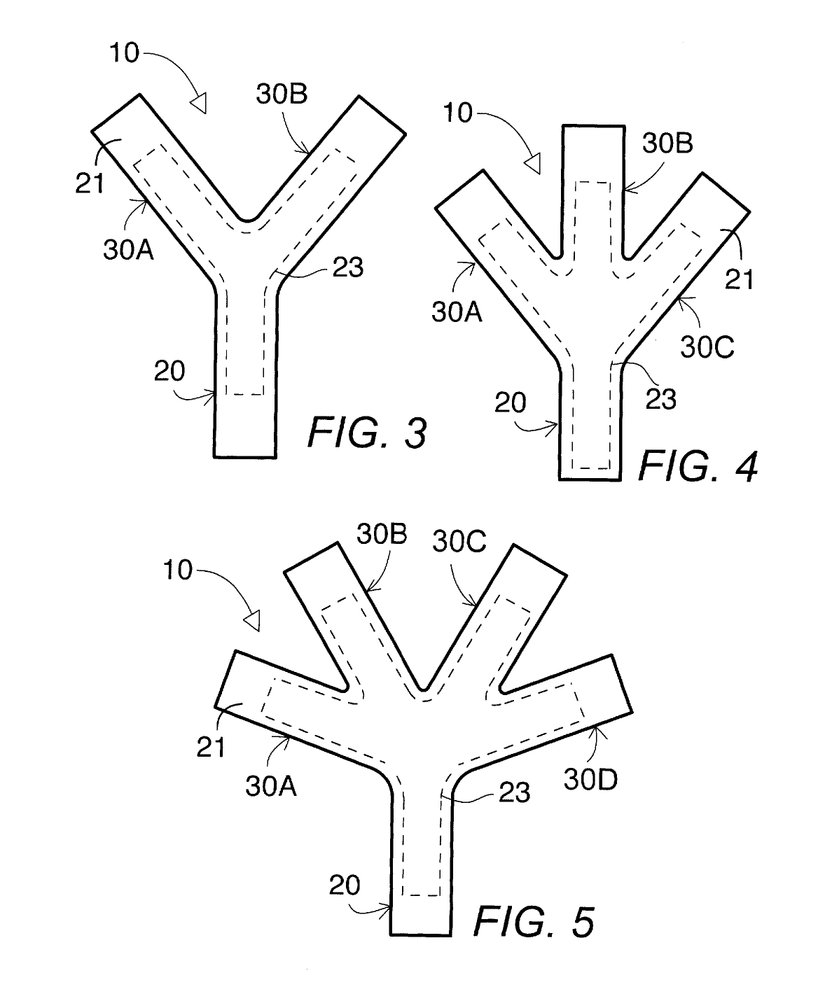

In FIGS. 1-18, a multiple wire connector device crimps a plurality of branch wires 50A and 50B to connect with a power or live wire 40, as shown in FIGS. 1 and 2, to serve multiple electrical components.

In FIGS. 1 and 2, a multi-wire connector body 10 comprises at least one first arm 20 configured to receive an electrical input wire 40 communicating with an electrical power source and at least two second arms 30A and 30B each configured to receive at least one electrical output wire 50A and 50B communicating with at least one component to receive electricity from each output wire 40. An interior electrically conductive material 23 interconnects the exposed ends 43 and 53A and 53B of the wires to transmit electricity between the wires. The electrically conductive material 23 comprises a malleable electrically conductive material crimped over an exposed end 43 and 53A and 53B of each of the wires inserted in each of the arms 20, 30A and 30B to secure the ends of the wires, as shown in FIG. 2.

An outer electrically insulating layer 21 surrounds the electrically conductive material 23 and the exposed ends 43, 53A and 53B of the wires to confine and insulate the malleable electrically conductive material and the exposed ends of the wires to insulate the electricity therein. The wires each having an outer electrical insulating layer 41, 51A and 51B extending out of the connector body thereby forming a multiple wire connector which crimps each wire in place and has its own outer electrical insulation 21 which overlaps the insulation 51A and 51B on the wires for a permanent instant multiple wire connector having its own insulation.

The malleable electrically conductive material 23 comprises at least one malleable electrically conductive material taken from the list of electrically conductive material comprising copper, nickel plated metal, aluminum, and an electrically conductive alloy.

The outer electrically insulating layer 21 comprises an electrically insulating waterproof synthetic material. The outer electrically insulating layer 21 may comprise a heat shrink material to form a permanent waterproof and electrically insulated coating over the entire connection. The outer electrically insulating layer 21 may be color coded to indicate wire size and intended use.

In FIGS. 1-18, the multiple wire connective device 10 may be configured in any of a wide variety of configurations with a multiplicity of different numbers of arms for different numbers of wires, each having an outer insulating shell 21 housing an inner electrically conductive material 23 (shown dashed) for crimping the wires together to conduct electricity between the wires. Other positions and numbers of live wire arms and distributor wire arms may be used for the variously shaped multiple wire connectors.

In FIGS. 1, 2, and 3, a Y shaped multiple wire connective device 10 has a bottom live wire arm 20 and two upper distributor wire arms 30A and 30B.

In FIG. 4, a three finger shaped multiple wire connective device 10 has a bottom live wire arm 20 and three upper distributor wire arms 30A, 30B, and 30C.

In FIG. 5, a four finger shaped multiple wire connective device 10 has a bottom live wire arm 20 and four upper distributor wire arms 30A, 30B, 30C, and 30D.

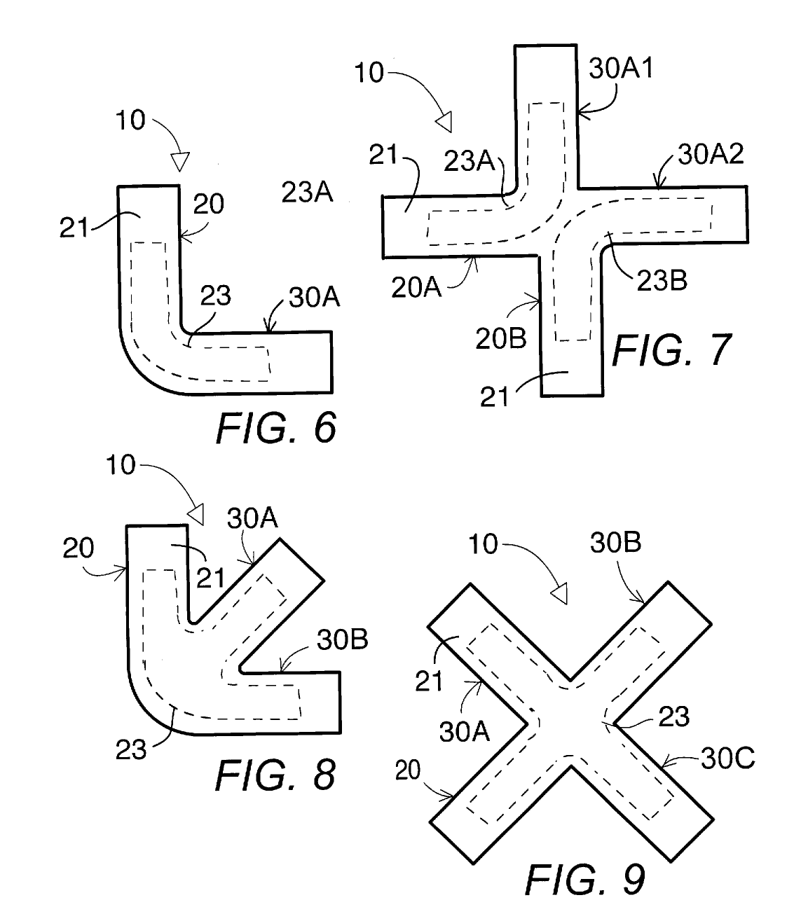

In FIG. 6, an elbow shaped multiple wire connective device 10 has a top live wire arm 20 and an orthogonal bottom distributor wire arm 30A.

In FIG. 7, a double L-shaped insulated electrical connector 10 has two separate L-shaped electrical conductors 23A and 23B (shown in dashed lines) within the outer electrical insulation 21, forming an overall cross shape, to connect between the left live wire arm 20A and the upper orthogonal distributor wire arm 30A1 and between the lower live wire 20B and the orthogonal right distributor wire arm 30A2.

In FIG. 8, an arrowhead-shaped insulated electrical connector 10 shows the electrical conductor 23 in dashed lines within the outer electrical insulation 21 to connect between the left vertical live wire arm 20 and the acute angled distributor wire arm 30A and the orthogonal distributor wire arm 30B.

In FIG. 9, an X-shaped (or cross-shaped) insulated electrical connector 10 of the present invention shows the electrical conductor 23 in dashed lines within the outer electrical insulation 21 to connect between the bottom left live wire arm 20 and the three distributor wire arms 30A, 30B, and 30C.

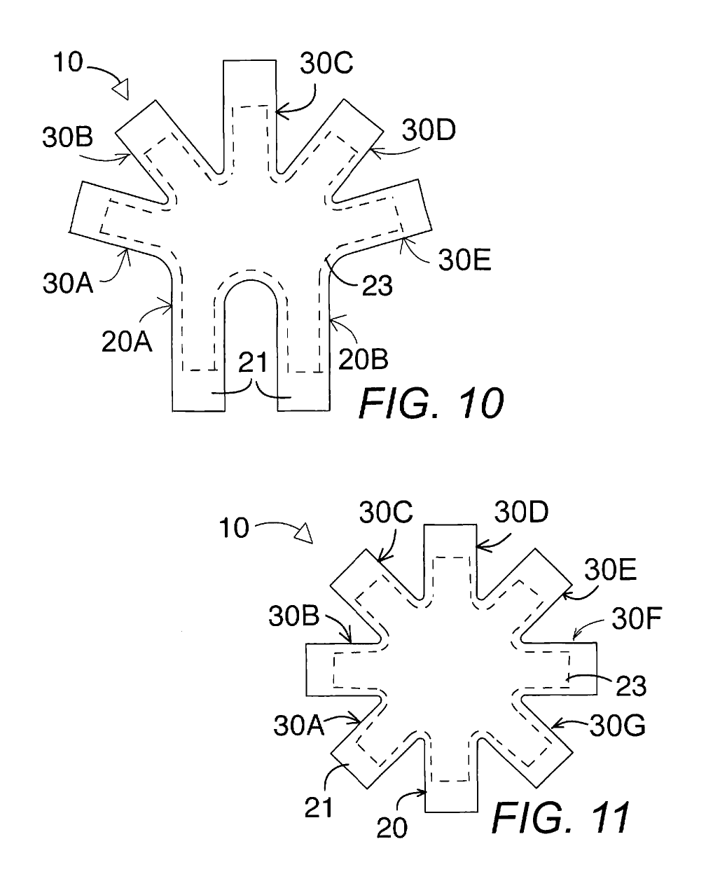

In FIG. 10, a five-fingered insulated electrical connector 10 shows the electrical conductor 23 in dashed lines within the outer electrical insulation 21 to connect between the two bottom live wire arms 20A and 20B and the five upper distributor wire arms 30A, 30B, 30C, 30D, and 30E.

In FIG. 11, an eight pointed star or pinwheel shaped insulated electrical connector 10 shows the electrical conductor 23 in dashed lines within the outer electrical insulation 21 to connect between the bottom live wire arm 20 and the seven distributor wire arms 30A-30G.

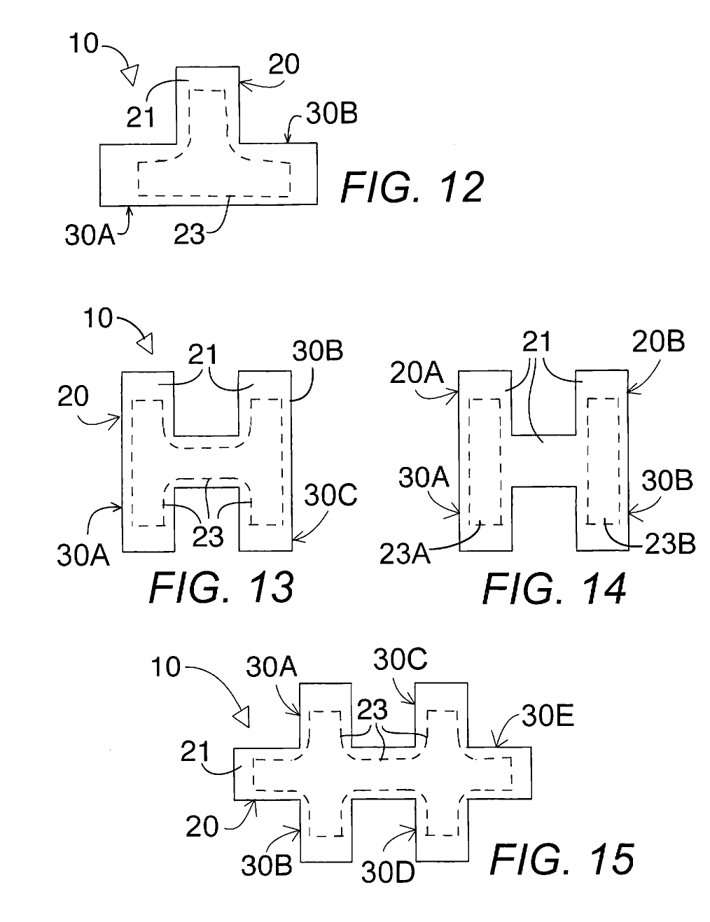

In FIG. 12, an inverted T-shaped insulated electrical connector 10 shows the electrical conductor 23 in dashed lines within the outer electrical insulation 21 to connect between the top live wire arm 20 and the two lower orthogonal distributor wire arms 30A and 30B.

In FIG. 13, an H-shaped insulated electrical connector 10 shows the electrical conductor 23 in dashed lines within the outer electrical insulation 21 to connect between the top left live wire arm 20 and the three distributor wire arms 30A, 30B, and 30C.

In FIG. 14, an H-shaped insulated electrical connector 10 shows two separate vertical electrical conductors 23 in dashed lines within the outer electrical insulation 21 to connect between the two upper live wire arms 20A and 20B and the two lower distributor wire arms 30A and 30B separately.

In FIG. 15, an H-shaped insulated electrical connector 10 has an extension of the center cross bar beyond the two verticals on both sides, and shows the electrical conductor 23 in dashed lines within the outer electrical insulation 21 to connect between the left live wire arm 20 and the five distributor wire arms 30A-30E.

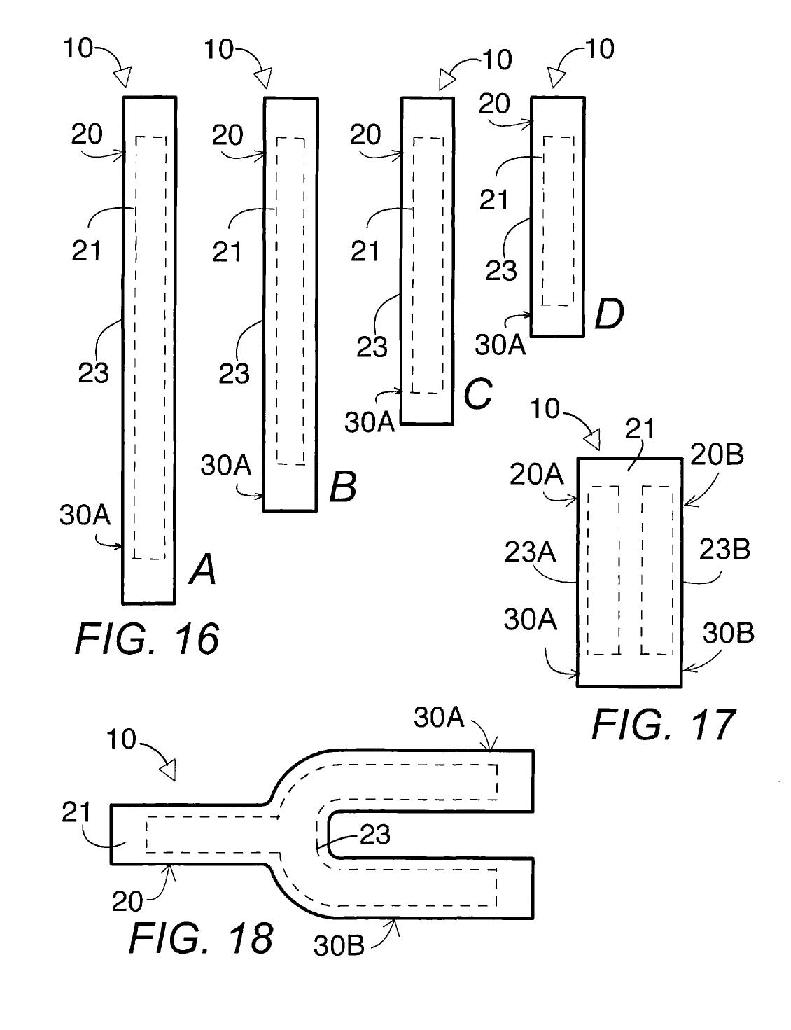

In FIG. 16A-16B, an elongated straight insulated electrical connector 10 shows the electrical conductor 23 in dashed lines within the outer electrical insulation 21 to connect between the top live wire arm 20 and the bottom distribution wire arm 30A over a wide variety of lengths of the connector to accommodate a wide variety of conditions with various space restrictions in electrical devices including parts restrictions or limited space for reaching the wiring. A range of 1 inch to 10 inches may be used or any other desired length to fit all requirements.

In FIG. 17 a rectangular insulated electrical connector 10 has two non-connected vertical electrical conductors 23A and 23B shown in dashed lines within the outer electrical insulation 21 to connect between the two upper live wire arms 20A and 20B and the two lower distributor wire arms 30A and 30B separately.

In FIG. 18, a tuning fork shaped insulated electrical connector 10 shows the electrical conductor 23 in dashed lines within the outer electrical insulation 21 and a left live wire arm 20 connecting with two right distributor wire arms 30A and 30B.

In use, the multi-wire insulated electrical connectors 10 of the present invention crimp a number of distributor wires to connect with at least one power wire to serve multiple electrical appliances or other electrical devices. Interior malleable electrically conductive material 23 may comprise a conductive metal including copper, nickel plated metal, aluminum or other conductive metal which crimps easily over existing wire ends inserted in the multi-wire connector. An outer insulation material 21, such as an electrically insulating waterproof synthetic material, overlaps the insulation on the wires for a permanent instant multiple wire connector having its own insulation.

Each multi-wire insulated electrical connector 10 is sized to connect wires of specific gauges for a tight fit therein with an electrically insulated weather tight fit. The outer surface may be heat shrink material to form a permanent waterproof and electrically insulated coating over the entire connection.

A wide variety of shapes and sizes and colors, including clear outer insulation material, of multi-wire connectors may be fabricated for different uses and with different numbers of connector arms depending upon how many wires need to be interconnected. Color coding may indicate the intended application of each multi-wire electrically insulated connector. Lengths of multi-wire connectors may vary for space needs in fitting them into electrical apparatus. Multi-wire connectors may have a wide variety of internal diameters between different connectors and within the same connector to receive the internal electrical conductors to engage all the different gauges of wires.

It is understood that the preceding description is given merely by way of illustration and not in limitation of the invention and that various modifications may be made thereto without departing from the spirit of the invention as claimed.

What is claimed is:

1. A multiple wire connector device which crimps a plurality of branch wires to connect with a power wire to serve multiple electrical components, the device comprising:
a multi-wire connector body comprising at least one first arm configured to receive an electrical input wire communicating with an electrical power source; and at least two second arms each configured to receive at least one electrical output wire communicating with at least one component to receive electricity from each output wire, an interior electrically conductive material interconnecting the wires to transmit electricity between the wires, the electrically conductive material comprising a malleable electrically conductive material crimped over an exposed end of each of the wires inserted in each of the arms to secure the ends of the wires therein;
an outer electrically insulating layer surrounding the electrically conductive material and the exposed ends of the wires to confine and insulate the malleable electrically conductive material and the exposed ends of the wires to insulate the electricity therein, the wires each having an outer electrical insulating layer extending out of the connector body thereby forming a multiple wire connector which crimps each wire in place and has its own outer electrical insulation which overlaps the insulation on the wires for a permanent instant multiple wire connector having its own insulation.

2. The multiple wire connective device of claim 1 wherein the malleable electrically conductive material comprises at least one malleable electrically conductive material taken from the list of electrically conductive material comprising copper, nickel plated metal, aluminum, and an electrically conductive alloy.

3. The multiple wire connective device of claim 1 wherein the outer electrically insulating layer comprises an electrically insulating waterproof synthetic material.

4. The multiple wire connective device of claim 1 wherein the outer electrically insulating layer comprises a heat shrink material to form a permanent waterproof and electrically insulated coating over the entire connection.

5. The multiple wire connective device of claim 1 wherein the outer electrically insulating layer is color coded to indicate wire size and intended use.

6. The multiple wire connective device of claim 1 configured in any of the configurations taken from the list of configurations consisting of a Y shape, a T shape, an H shape, a star shape, a multi-fingered shape, an L shape, a double L interconnected shape, a cross shape, a bisected angle shape, a tuning fork shape, a parallel line shape, and an H shape with an extending horizontal element.
